(19) United States
(12) Patent Application Publication
(10) Pub. No.: US 2007/0121549 A1
(43) Pub. Date: May 31, 2007

(54) Fast handover method and apparatus

(75) Inventors: Won-dong Yun, Seoul (KR); Young-keun Kim, Incheon Metropolitan-city (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/602,995

(22) Filed: Nov. 22, 2006

(30) Foreign Application Priority Data
Nov. 25, 2005 (KR) 2005-113488

(51) Int. Cl. H04Q 7/00

(52) U.S. Cl. 370/331

(57) ABSTRACT

A fast handover method and apparatus for a mobile node between sub-networks by using a predictive algorithm includes: identifying a sub-network which is likely to be connected to a mobile node; requesting detection of whether an address of the mobile node which is to be used in the sub-network is already used in the sub-network; and selectively requesting performance of a binding update of the mobile node based on a response to the request. Accordingly, it is possible to prevent or reduce handover delay caused by the duplicate address detection.

### CROSS-REFERENCE TO RELATED APPLICATION

This application claims the benefit of Korean Application No. 2005-113488, filed Nov. 25, 2005 in the Korean Intellectual Property Office, the disclosure of which is incorporated herein by reference.

### BACKGROUND OF THE INVENTION

1. Field of the Invention

Aspects of the present invention relate to a fast handover method and apparatus of a mobile node between sub-networks and a handover supporting method and apparatus. More particularly, aspects of the present invention relate to a fast handover method and apparatus of a mobile node between sub-networks using a predictive algorithm and a handover supporting method and apparatus.

2. Description of the Related Art

FIG. 1 is a schematic showing a mobile communication environment according to a related art mobile “Internet Protocol version 6” (IPv6) standard. Referring to FIG. 1, the mobile communication environment includes a mobile node (MN) 1, access points (APs) AP1 21 and AP2 22, a previous access router (PAR) 31, a new access router (NAR) 32, a home agent (HA) 4, and a correspondent node (CN) 5.

As shown, the AP1 21 manages a basic service set (BSS) BSS1 and wirelessly communicates with the MN 1 included in the BSS1. The PAR 31 manages a sub-network 1 and wirelessly communicates with the AP1 21 included in the sub-network a. Accordingly, the MN 1 can access the Internet via the AP1 21 and the PAR 31, and communicates with the HA 4 or the CN 5 which also access the Internet. In addition, the AP2 22 manages a BSS2 and wirelessly communicates with the MN 1 included in the BSS2. The NAR 32 manages a sub-network b and communicates with the AP2 22 included in the sub-network b. Accordingly, the MN 1 can access the Internet via the AP2 22 and the NAR 32, and communicates with the HA 4 or the CN 5 which also access the Internet. Accordingly, the MN 1 is able to move from the BSS1 managed by the AP1 21 to the BSS2 managed by the AP2 22 and maintain communication with HA 4 and/or CN5 via the internet.

As shown, the HA 4 is a router that has the registration information of the MN 1. HA 4 is one of the routers located in a home network of the MN 1. Particularly, when the MN 1 is not located in a home network thereof, the HA 4 intercepts packets which are directed to the home address of the MN 1 and tunnels the packets to a care-of-address (COA) of the MN 1 used in a sub-network where the MN 1 is currently located. Accordingly, although the MN 1 moves between the sub-networks, the MN 1 can receive the packets which are directed to the home address of the MN 1 regardless of which of the sub-networks the MN1 is located. However, in order to implement such a configuration, the MN 1 must notify the HA 4 of the current COA thereof.

FIG. 2 is a diagram of a handover method according to the related art mobile IPv6 standard. The handover method is disclosed in “Request For Comments” (RFCs) 3775. Referring to FIG. 2, the handover method includes operations which are sequentially carried out in the mobile communication environment shown in FIG. 1.

As shown, in operation 201, the NAR 32 multicasts a router advertisement (RA) message, and the MN 1 receives the multicasted RA message from the NAR 32. The MN 1 recognizes that the MN 1 is moving from the sub-network a to the sub-network b because of a prefix of the sub-network b included in the RA message from the NAR 32. The RA message from the NAR 32 may be a message which is periodically multicasted by the NAR 32 or a message in response to a router solicitation (RS) message from the MN 1.

In operation 202, the MN 1 generates a COA of the MN 1 by combining the prefix of the sub-network b included in the received RA message and an Interface ID of the MN 1, and performs a duplicate address detection (DAD) operation for the generated COA.

In operation 203, when the DAD result of operation 202 indicates that the generated COA for the MN 1 is not used by an arbitrary node included in the sub-network b, the MN 1 transmits to the HA 4 a binding update (BU) message to request binding of the generated COA with the home address of the MN 1. The HA 4 then receives the BU message.

In operation 204, the HA 4 performs a binding update (BU) for the MN 1 by binding the generated COA included in the received BU message received in operation 203 with the home address of the MN 1.

In operation 205, the HA4 transmits a binding acknowledgement (BAck) message to acknowledge that the BU of the MN 1 was normally performed, and the MN 1 receives the transmitted BAck message.

In operation 206, since the CN 5 cannot recognize that the MN 1 moves from the sub-network a to the sub-network b, the CN 5 continues to transmit the packets which are directed to the home address of the MN 1. Subsequently, the HA 4 intercepts the packets which are directed to the home address of the MN 1 and tunnels the packets to the COA that has been bound to the home address of the MN 1 through the BU in operation 205. Accordingly, the MN 1 receives the packets.

In the above, operations 201 to 206 are carried out during a wireless overlap interval, which is an interval from a time when the MN 1 is completely apart from the sub-network a to a time when the MN 1 completely enters the sub-network b. Meanwhile, in order to perform the DAD of the COA of the MN 1, a neighbor solicitation (NS) message and a neighbor advertisement (NA) message must be transmitted and received. However, it takes up to one second to perform the transmission and reception of the NA and NS messages. As a result, handover delay occurs after the wireless overlap interval, and the communication is disconnected between the MN 1 and the sub-networks a and b.

FIG. 3 is a diagram of a fast handover method according to the related art mobile IPv6 standard. The fast handover method shown in FIG. 3 is disclosed in RFC 4068 as a technique to solve the aforementioned problem. Referring to FIG. 3, the fast handover method according to the related art mobile IPv6 standard includes operations as follows.

In operation 301, when the MN 1 detects a new sub-network b, the MN 1 transmits a router-solicitation-for-proxy-advertisement (RtSolPr) message to the PAR 31 to request information on the handover from the sub-network a to the sub-network b, and the PAR 31 receives the RtSolPr message.

In operation 302, the PAR 31 transmits to the MN 1 a proxy-router-advertisement (PrRtAdv) message that includes the information on the handover from the sub-network a to the sub-network b as a response to the RtSolPr message that was received in operation 301, and the MN 1 receives the PrRtAdv message. The information on the handover from the sub-network a to the sub-network b may include the prefix of the sub-network b and the like. Accordingly, the MN 1 can generate the COA thereof when the MN 1 is still connected to the PAR 31.

In operation 303, when the MN 1 detects the connection to the sub-network b, the MN 1 transmits a fast binding update (BU) message to the PAR 31 to request binding of the newly generated COA with the previous COA of the MN 1 with reference to the PrRtAdv message received in operation 302, and the PAR 31 receives the fast BU message.

In operation 304, the PAR 31 binds the new COA included in the fast BU message received in operation 303 with the previous COA of the MN 1. The PAR 31 transmits a handover initiate (HI) message to the NAR 31 to enquire whether the new COA can be used, and the NAR 32 receives the Hi message. Accordingly, the NAR 32 checks whether or not the new COA included in the fast BU message can be used.

In operation 305, the NAR 32 transmits to the PAR 31 a handover acknowledge (HAck) message to the PAR 31 indicating whether or not the new COA for the MN 1 can be used as a response to the Hi message transmitted in operation 304, and the PAR 31 receives the HAck message.

In operation 306, when the received HAck message of operation 305 indicates that the new COA for the MN 1 can be used, the PAR 31 transmits a fast binding acknowledge (FBAck) message as a response to the received fast BU message received of operation 303. The FBAck message is sent to and received by the PAR 31 and the NAR 32.

In operation 307, when the MN 1 and the PAR 31 are disconnected from each other, the NAR 32 transmits packets received from the MN 1 using the BU of operation 304.

In operation 308, when the MN 1 does not receive the fast BAck message when the MN 1 and the NAR 32 are connected to each other, the MN 1 transmits to the NAR 32 a fast neighbor advertisement (FNA) message to confirm that the new COA is usable, and uses the new COA.

However, in the aforementioned related art fast handover method of FIG. 3, the RtSolPr, PrRtAdv, HI message, and HAck messages are newly-introduced messages different from the messages which are used in related art handover method of FIG. 2. Accordingly, a problem of increased load of the MN 1 occurs. In addition, since mobile IP stacks for the router and the MN 1 must be modified, a problem of increased cost involved in employing the fast handover method occurs.

### SUMMARY OF THE INVENTION

According to aspects of the present invention, a fast handover method and apparatus of a mobile node between sub-networks uses only existing message types of the mobile IPv6 standard instead of using separately defined message types, and also includes and a fast handover supporting method and apparatus.

Aspects of the present invention also include one or more computer readable recording media having embodied thereon more or more computer programs for the fast handover method and the fast handover supporting method.

According to an aspect of the present invention, a handover method includes: identifying a sub-network which is likely to be connected to a mobile node; requesting for detecting whether or not an address of the mobile node which is to be used in the sub-network is used; and selectively requesting for performing binding update of the mobile node based on a response to the request.

According to another aspect of the present invention, a handover apparatus includes: a prediction unit which predicts a sub-network which is likely to be connected to a mobile node; a request unit which requests for detecting whether or not an address of the mobile node which is to be used in the sub-network is used; and a binding request unit which selectively requests for performing binding update of the mobile node based on a response to the request.

According to another aspect of the present invention, a computer readable recording medium having embodied thereon a computer program for a computer to perform the aforementioned handover method.

According to another aspect of the present invention, a handover supporting method includes: detecting whether or not an address of a mobile node which is to be used in a sub-network which is predicted to be likely to be connected to the mobile node is used according to a request of the mobile node; transmitting a response including a result of the detecting; and performing binding update of the mobile node according to a request of the mobile node which receives the response.

According to another aspect of the present invention, a handover supporting apparatus includes: a detection unit which detects whether or not an address of a mobile node which is to be used in a sub-network which is predicted to be likely to be connected to the mobile node is used according to a request of the mobile node; a responding unit which transmits a response including a result of the detecting of the detection unit; and a binding update unit which performs binding update of the mobile node according to a request of the mobile node which receives the response.

According to another aspect of the present invention, one or more computer readable recording media having embodied thereon a computer program for one or more computers to perform the aforementioned handover supporting method.

According to another aspect of the present invention, a fast handover method between one sub-network and another sub-network and involving a mobile node and a home agent includes: the mobile node detecting the another sub-network as a next visited sub-network; the mobile node generating a care-of-address for use in the another sub-network; the mobile node forwarding the care-of-address and a duplicate address detection request based on the care-of-address to the home agent; the home agent performing the duplicate address detection to determine if the care-of-address is usable in the another sub-network; and if usable, the mobile node requesting a binding update of the care-of-address to a home address of the mobile node.

According to another aspect of the present invention, a system of a fast handover method involving a mobile node and a home agent includes: the mobile node identifying at a sub-network which is likely to be connected to a mobile node; the mobile node requesting detection by the home agent of whether an address of the mobile node which is to be used in the sub-network is already used in the sub-network; the home agent detecting whether the address of the mobile node is already used according to the detection request of the mobile node; the home agent transmitting a response to the detection request including a result of the detection to the mobile node; the mobile node selectively requesting performance of a binding update of the address based on the response to the detection request generated by the home agent; and the home agent performing the binding update of the address of the mobile node according to the request of the mobile node which receives the response.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent more readily appreciated from the following description of the aspects, taken in conjunction with the accompanying drawings of which:

FIG. 1 is a schematic showing a mobile communication environment according to a related art mobile IPv6 standard;

FIG. 2 is a diagram of a handover method according to a related art mobile IPv6 standard;

FIG. 3 is a diagram of a fast handover method according to another related art mobile IPv6 standard;

FIG. 4 is a schematic showing a mobile communication environment according to an aspect of the present invention;

FIG. 5 is a diagram of a handover method and a handover supporting method according to an aspect of the present invention;

FIG. 6A is a format of a related art BU message, and FIG. 6B is a format of a fast BU message according to an aspect of the present invention;

FIG. 7 is a format of a BAck message according to an aspect of the present invention;

FIG. 8 is a schematic of configurations of MN and HA according to aspects of the present invention;

FIG. 9 is a flowchart of a handover method according to an aspect of the present invention; and

FIG. 10 is a flowchart of a handover supporting method according to another aspect of the present invention.

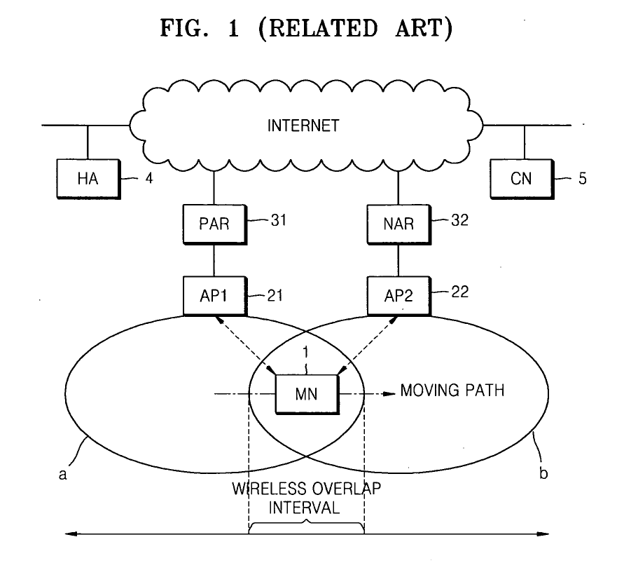

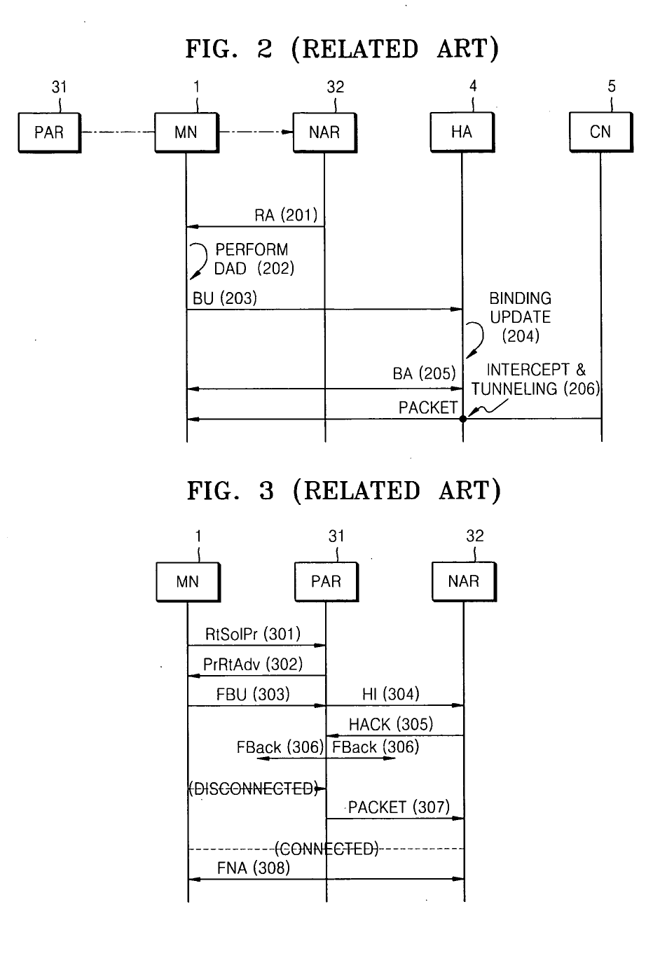

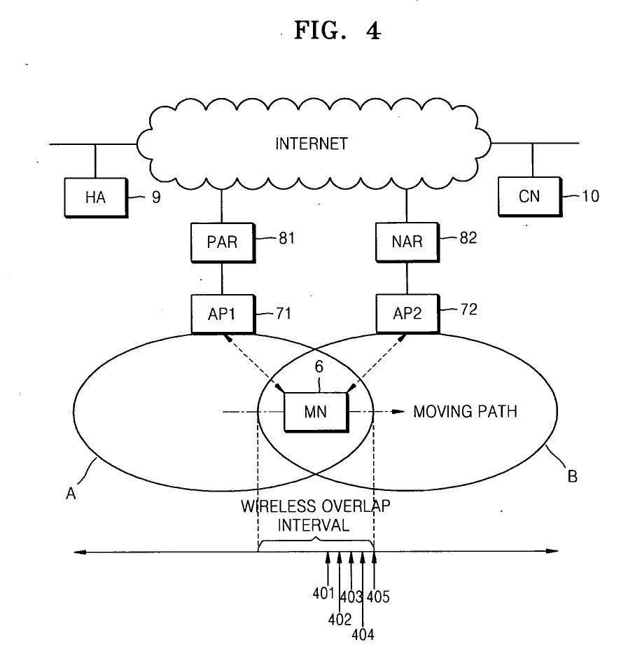

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

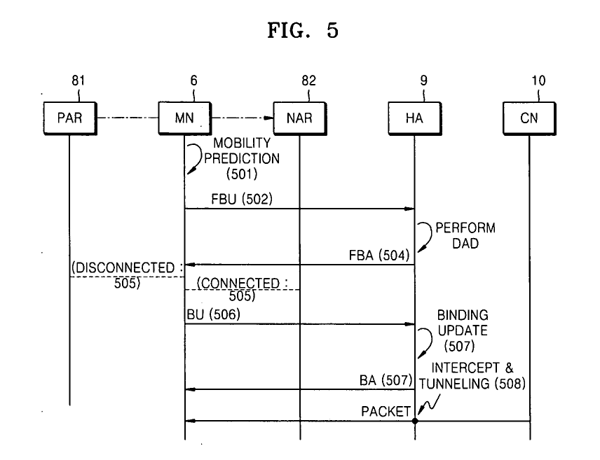

FIG. 4 is a schematic showing a mobile communication environment according to an aspect of the present invention. Referring to FIG. 4, the mobile communication environment includes a mobile node (MN) 6, access points (APs) AP1 71 and AP2 72, a previous access router (PAR) 81, a new access router (NAR) 82, a home agent (HA) 9, and a correspondent node (CN) 10.

As shown, the AP1 71 manages a basic service set (BSS) BSS1 and wirelessly communicates with the MN 6 included in the BSS1. The PAR 81 manages a sub-network A and wirelessly communicates with the AP1 71 included in the sub-network A. Accordingly, the MN 6 can access the Internet via the AP1 71 and the PAR 81, and can communicate with the HA 9 or the CN 10 which also access the Internet. In addition, the AP2 72 manages a basic service set (BSS) BSS2 and wirelessly communicates with the MN 6 included in the BSS2. The NAR 82 manages a sub-network B and communicates with the AP2 72 included in the sub-network B. Accordingly, the MN 6 can access the Internet via the AP2 72 and the NAR 82, and can communicate with the HA 9 or the CN 10 which also access the Internet. Accordingly, the MN 6 is able to move from the BSS1 managed by the AP1 71 to the BSS2 managed by the AP2 72.

As shown, the HA 9 includes a router that has the registration information of the MN 6. The HA 9 is one of the routers located in a home network of the MN 6. Particularly, when the MN 6 is not located in a home network thereof, the HA 9 intercepts packets which are directed to the home address of the MN 6 and tunnels the packets to a care-of-address (COA) of the MN 6 used in a sub-network (visited network) where the MN 6 is currently located. Accordingly, although the MN 6 moves between the sub-networks, the MN 6 can receive the packets which are directed to the home address of the MN 6. However, in order to implement such a configuration, the MN 6 must notify the HA 9 of the current COA thereof.

During a movement of the MN 6, when the MN 6 is located in an overlap interval of the BSS1 and the BSS2, (the overlap interval being an interval where wireless signals transmitted from the AP1 71 and the AP2 72 overlap with each other) the MN 6 can simultaneously receive information of the sub-network A provided by the AP1 71 and the information of the sub-network B provided by the AP2 72. In the following aspects, the HA 9 performs the duplicate address detection (DAD) of the COA for the MN 6 during the wireless overlap interval. Such is different from a related art DAD where it is the MN that performs the DAD. In general, the HA 9 is more robust and has a much better performance than the MN 6. Accordingly, the HA 9 can perform the DAD of the. COA for the MN 6 much faster than the MN 6.

FIG. 5 is a diagram of a handover method and a handover supporting method according to an aspect of the present invention. Referring to FIG. 5, the handover method and the handover supporting method according to an aspect of the present invention includes operations which are sequentially carried out in the mobile communication environment shown in FIG. 4.

As shown, in operation 501, the MN 6 predicts (senses, detects, determines, and/or identifies) the sub-network B, which is a sub-network that is likely to be connected to the MN 6. Operation 501 is performed at a point of time 401 that is within the wireless overlap interval shown in FIG. 4. The time 401 is when the MN 6 is closer to the BSS2 than to the BSS1. That is, time 401 is when the MN 6 draws closer to the sub-network B and away from the sub-network A.

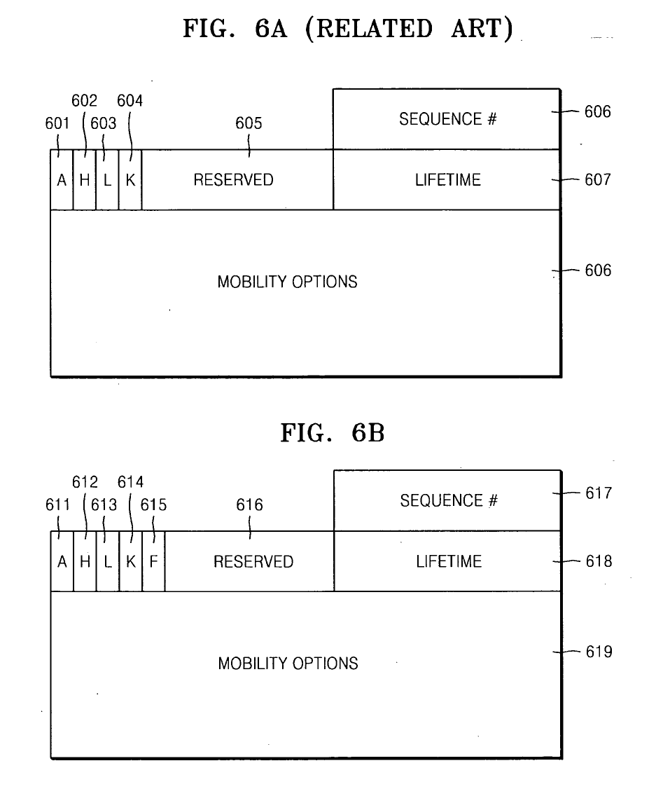

In operation 502, the MN 6 makes or forwards a request for the DAD of the COA for the MN 6. The HA 9 then receives the request. Namely, in operation 502, the MN 6 transmits a message requesting detection or determination of whether or not the COA for the MN 6 to be used in the sub-network B is already used by an arbitrary node (a node) included in the sub-network B. The HA 9 then receives the request message. The request message may be in the fast BU message format shown in FIG. 6B.

FIG. 6A is a view showing a format of a related art BU message, and FIG. 6B is a format of a fast BU message according to an aspect of the present invention. Referring to FIG. 6A, the related art BU message format includes an acknowledge field A 601, a home registration field H 602, a link-local address compatibility field L 603, a key management mobility capability field K 604, a reserved field 605, a sequence number field 606, a lifetime field 607, and a mobility option field 608.

Recorded in the field A 601 is a value or an indicator requesting to receive the BU message and to transmit the BAck message. Recorded in the field H 602 is a value or an indicator requesting a node that receives the BU message to act as a HA. Recorded in the field L 603 is a value or an indicator that refers to the home address of the MN 6 that includes an interface ID of a link-local address of the MN. Recorded in the field K 604 is a value or an indication that refers to whether or not a manual “Internet Protocol SECurity” (IPSEC) is set.

The reserved field 605 is not used but kept in reserve. Recorded in the sequence number field 606 is a value or an indication that refers to a sequence number of the BU message. The sequence number field 606 is used to match the BU message with the BAck message that is a response to the BU message. Recorded in the lifetime field 607 is a value or an indication that refers to a lifetime of the binding. When the value of the lifetime field 607 is 0, for example, a binding cache entry of the MN is eliminated. Recorded in the mobility option field 608 is a value or an indication that refers to mobility options such as a binding authorization data option, a nonce indices option, and/or an alternative COA option.

Referring to FIG. 6B, the fast BU message according to an aspect of the present invention includes an acknowledge field A 611, a home registration field H 612, a link-local address compatibility field L 613, a key management mobility capability field K 614, a fast field F 615, a reserved field 616, a sequence number field 617, a lifetime field 618, and a mobility option field 619.

As show in FIG. 6B, the fast BU message includes the field F 615. In another aspect, the field F 615 may be added to the reserved field 605 of the related art BU message of FIG. 6A. Recorded in the F field 615 is a value or an indicator that refers to a request to detect whether or not the COA for the MN 6 is used by an arbitrary node (e.g., any of the nodes) included in the sub-network B. In particular, if the COA for the MN 6 is used by an arbitrary node, then in the mobility option field 619, the COA for the MN 6 is recorded by using an alternative COA for the MN 6.

In operation 503, the HA 9 performs the DAD of the COA for the MN 6 in response to the request received in operation 502. Namely, in operation 503, in response to the request received in operation 502, the HA 9 detects whether or not the COA for the MN 6 to be used in the sub-network B is already used by an arbitrary node.

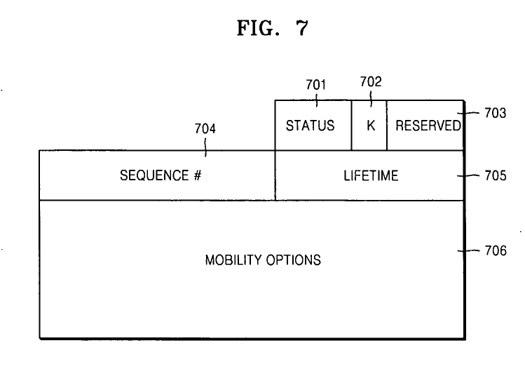

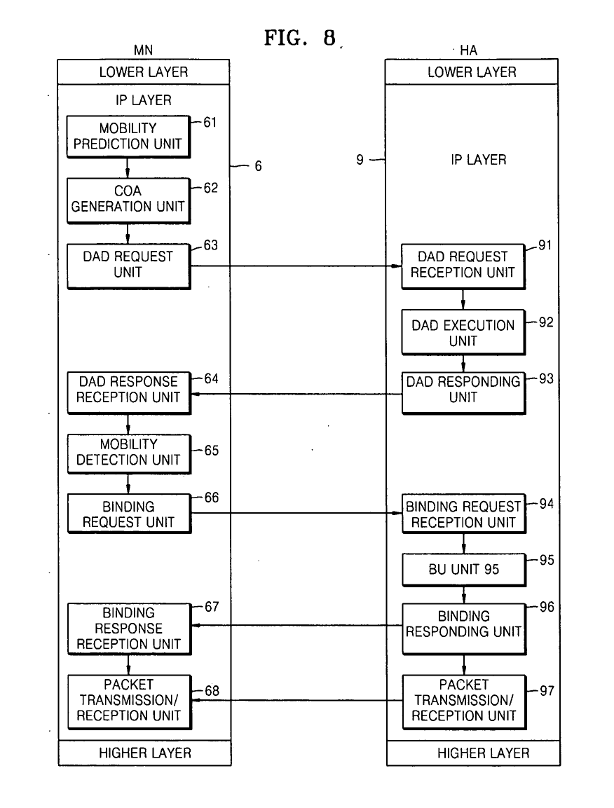

In operation 504, the HA 9 transmits a response message that includes the DAD determination result of operation 503, and the MN 6 receives the response message. Namely, in operation 504, the HA 9 transmits the response message that includes the detected result of whether or not the COA included in the fast BU message is already used, and the MN 6 receives the response message. The response message may be a BAck message shown in FIG. 7, which is the same format as a related art BAck message format. Since the response message is a BAck message for the fast BU message, the response message is referred as a fast BAck message.

FIG. 7 is a format of the related art BAck message according to an aspect of the present invention. Referring to FIG. 7, the BAck message includes a status field 701, a key management mobility capability field K 702, a reserved field 703, a sequence number field 704, a lifetime field 705, and a mobility option field 706.

Recorded in the status field 701 is a value or an indication that refers to the result of the BU of the MN 6. For example, when the value recorded in the status field 701 is 0, the value refers to the success of the BU of the MN 6. When the value recorded in the status field 701 is 136, for example, the value refers to the failure of the DAD of the COA for the MN 6 (i.e., the COA is already used). Particularly, recorded in the status field 701 of the fast BAck message according to an aspect is a value that refers to the result of the DAD request in operation. Namely, when the value recorded in the status field 701 is 0, for example, the value refers to the fact that the COA for the MN 6 is detected as not being used by an arbitrary node. When the value recorded in the status field 701 is 136, for example, the value refers to the fact that the COA for the MN 6 is detected as being used by an arbitrary node. In various aspects, values other than 0 or 136 may be used for the various indication of the status field 701.

Recorded in the field K 702 is a value or an indicator that refers to whether or not a manual IPSEC is set. The reserved field 703 is not used but is reserved. Recorded in the sequence number field 704 is a value or an indication that refers to a sequence number of the BU message. The sequence number field 704 is used to match the BU message with the BAck message that is a response to the BU message. Recorded in the lifetime field 705 is a value that refers to a lifetime of the binding. When a value of the lifetime field 705 is 0, for example, a binding cache entry of the MN is eliminated. Recorded in the mobility option field 706 is a value or an indication that refers to mobility options such as a binding authorization data option and a binding refresh advice option. In various aspects, values other than 0 or 136 may be used for the various indication of the lifetime field 705.

Referring back to FIG. 5, operations 502 to 504 are performed at times 402 to 404 shown in FIG. 4. These times are after the time the MN 6 is completely apart from the BSS1 and before the time when the MN 6 completely enters the BSS2. Namely, operations 502 to 504 are performed during an interval after the MN 6 is completely apart from the BSS1 and before the MN 6 completely enters the BSS2. This is because it takes a relatively long time for the MN 6 to completely enter the new sub-network B (of the BSS2) after the wireless overlap interval and because up to one second is generally spent on the DAD.

In operation 505, the MN 6 is disconnected from the AP1 71 (to which the MN 6 was previously connected to in the sub-network A), and the MN 6 is connected to the AP2 72 (to which the MN 6 is predicted to be likely to be connected to in the sub-network B). Operation 505 is performed at the time 404 shown in FIG. 4. The time 404 is after the time when the MN 6 is completely apart from the BSS1, namely, the sub-network A.

In operation 506, when the DAD result in the fast BAck message received in operation 505 refers to the fact that the COA for the MN 6 is detected to be not used, the MN 6 requests for binding of the COA with the home address of the MN 6. The HA 6 then receives the request. Namely, in operation 506, the MN 6 transmits the BU message that includes the COA which is detected to be not used by an arbitrary node included in the sub-network B, and the HA 9 receives the BU message. The format of the BU message is that shown in FIG. 7, though not required. Accordingly, the BU message has the same function as the related art BU message shown in FIG. 6A.

In operation 507, the HA 9 binds the COA of the BU message received in the operation 506 with the home address of the MN 6 and performs the BU of the MN 6. In operation 508, the HA 9 transmits the BAck message to acknowledge that the BU of the MN 6 has been normally (successfully) performed. The MN 6 then receives the BAck message. In operation 509, the HA 9 intercepts the packets which are directed to the home address of the MN 6 and tunnels the packets to the COA that has been bound with the home address of the MN 6 during the BU of operation 507. The MN 6 then receives the tunneled packets.

Operations 506 to 509 are carried out in an interval after the time 405 shown in FIG. 4. The interval shown is one where the MN 6 is connected to the AP2 72 that is managing the BSS2 (namely, the sub-network B). In addition, operations following operation 509 are carried out according to the mobile IPv6 standard.

As discussed above, the MN 6 predicts (senses, detects, determines, and/or identifies) the sub-network which is likely to be connected to the MN 6 in the interval before the time 405, and the DAD of the COA which is to be used in the sub-network is performed. Accordingly, it is possible to remove or reduce a handover delay caused by the DAD operation being performed by an MN. In addition, the aforementioned operations are performed by using only the BU and BAck messages according to the mobile IPv6 standard without using a separately defined message. Accordingly, it is possible to reduce the load on the MN and the cost involved in a fast handover method as compared to that of the related art fast handover method.

FIG. 8 is a schematic of configurations of the MN and the HA according to an aspect of the present invention. Referring to FIG. 8, a handover apparatus in the form of the MN 6 according to an aspect of the present invention includes a mobility prediction unit 61, a COA generation unit 62, a DAD request unit 63, a DAD response reception unit 64, a mobility detection unit 65, a binding request unit 66, a binding response reception unit 67, and a packet transmission/reception unit 68. These components are loaded on the IP layer of the MN 6 shown in FIG. 5.

The mobility prediction unit 61 predicts (senses, detects, determines, and/or identifies) the sub-network B (namely, a sub-network which is likely to be connected to the MN 6). The mobility prediction unit 61 may use various methods to predict the sub-network as follows. Namely, the mobility prediction unit 61 may use a global positioning system (GPS) to predict the sub-network which is likely to be connected to the MN 6. For example, the mobility prediction unit 61 may receive position information of the MN 6 from a GPS satellite and measures distances between the MN 6 and various access points (APs) based on the position information. As a result of the measurement, when the distance between the MN 6 and an AP2 72 among the various APs is less than a threshold value, the sub-network (such as sub-network B) in which the AP2 72 is included is determined as a sub-network which is likely to be connected to the MN 6.

In other aspects, the mobility prediction unit 61 may use intensities of wireless LAN signals radiated from the various APs to predict the sub-network which is likely to be connected to the MN 6. For example, the mobility prediction unit 61 may measure the intensities of the wireless LAN signals radiated from the various APs. As a result of the measurement, when the intensity of the wireless LAN signal radiated from one of the APs among the various APs (such as the AP2 72) is more than a threshold value, the sub-network in which the AP2 72 is included is determined as a sub-network which is likely to be connected to the MN 6.

The COA generation unit 62 receives a router advertisement (RA) message from the NAR 82 that manages the sub-network B which is predicted to be likely to be connected to the MN 6. The RA message includes a prefix of the sub-network B. The COA generation unit 62 generates the COA for the MN 6 by combining the prefix of the sub-network included in the RA message with the Interface ID of the MN 6. In addition, the COA generation unit 62 generates another COA that is different from the COA generated previously when the status field 701 of the fast BAck message received by the DAD response reception unit 64 indicates that the COA generated by the COA generation unit 62 is detected to be in use. In various aspects, though not required, the value that indicates use may be 136, for example.

The DAD request unit 63 forwards or makes a request to the HA 9 for the DAD of the COA generated by the COA generation unit 62. Namely, the DAD request unit 63 request the HA 9 to detect whether or not the COA for the MN 6 to be used in the sub-network (which is predicted to be likely to be connected to the MN 6) is used by an arbitrary node included in the sub-network B. That is, the DAD request unit 63 transmits the fast BU message including the COA for the MN 6 to the HA 9 to request the DAD.

The DAD response reception unit 64 receives a response to the request for DAD that was forwarded by the DAD request unit 63. That is, the DAD response reception unit 64 receives a fast BAck message that includes a detected result of whether or not the COA generated by the COA generation unit 62 is already used or is usable.

Thereafter, the mobility detection unit 65 is notified that the MN 6 is disconnected from the AP1 71 that is included in the sub-network A, and which was previously connected to the MN 6 in the link layer. The link layer is the lowest layer of the IP layers and is connected to the AP2 72 included in the sub-network B so that the connection of the MN 6 to the sub-network B is detected.

When the mobility detection unit 65 detects or determines that the MN 6 is likely to be connected to the sub-network B, the binding request unit 66 selectively requests the BU of the MN 6 based on the response to the request forwarded by the DAD request unit 63 upon the MN 6 becoming connected to the sub-network B. More specifically, the binding request unit 66 forwards or makes a request to the HA 6 to bind the home address of the MN 6 with the COA generated by the COA generation unit 62 when the status field 701 of the fast BAck message received by the DAD response reception unit 64 indicates that the COA generated by the COA generation unit 62 is not in use. In various aspects, though not required, the value that indicates non use is 0, for example. Particularly, the binding request unit 66 transmits the BU message to the HA 9 to request for the BU of the MN 6. The BU message includes the COA which is detected to be not used by an arbitrary node included in the sub-network B.

The binding response reception unit 67 receives a response to the BU request that was forwarded by the binding request unit 66. Particularly, the binding response reception unit 67 receives the BAck message to acknowledge that the BU of the MN 6 requested by the binding request unit 66 is normally (or successfully) performed. The BU message has the same function as the related art BU message shown in FIG. 6A. The format of the BU message is that shown in FIG. 6B.

Based on the BAck message received from the binding response reception unit 67, the packet transmission/reception unit 68 receives packets which are tunneled to the COA of the MN 6 by the HA 9. The packets are ones which are directed to the home address of the MN 6 by the CN 10. In various aspects, the DAD request unit 63, the DAD response reception unit 64, the binding request unit 66, the binding response reception unit 67, and packet transmission/reception unit 68 may be a single input/output unit. Also, in other aspects, the mobility prediction unit 61, the COA generation unit 62, and the mobility detection unit 65 may be performed by a single processing unit. In various aspects of the present invention, the units 61-68 may be integrated into a single unit.

Referring again to FIG. 8, a handover supporting apparatus in the form of the HA 9 includes a DAD request reception unit 91, a DAD execution unit 92, a DAD responding unit 93, a binding request reception unit 94, a BU unit 95, a binding responding unit 96, and a packet transmission/reception unit 97. These components are loaded on the IP layer of the HA 9 shown in FIG. 5.

The DAD request reception unit 91 receives from the MN 6 a DAD request for the COA for the MN 6 used in the sub-network B. Namely, the DAD request reception unit 91 receives from the MN 6 a fast BU message (a DAD request message) that includes the COA for the MN 6 which is used in the sub-network B.

The DAD execution unit 92 detects whether or not the COA for the MN 6 is already used or is usable according to the request received from the DAD request reception unit 91. Namely, when a value or an indication that refers to the request to detect whether or not the COA for the MN 6 is used is recorded in the field F 615 of the BU message received from the DAD request reception unit 91, the DAD execution unit 92 determines that the BU message received by the DAD request reception unit 91 is the fast BU message. Next, the DAD execution unit 92 detects whether or not the COA recorded in the mobility option field 619 of the fast BU message is used or usable.

More specifically, the DAD execution unit 92 multicasts a neighbor solicitation (NS) message whose target address is the received COA recorded in the mobility option field 619 of the fast BU message. Subsequently, the DAD execution unit 92 receives a neighbor advertisement (NA) message, which is a response message for the NS message, and detects from the NA message whether or not the received COA recorded in the mobility option field 619 of the fast BU message is used by an arbitrary node (other or any of the nodes) included in the sub-network B.

The DAD responding unit 93 transmits a response that includes a result of the above DAD from the DAD execution unit 92 to the MN 6. Namely, when the DAD execution unit 92 detects that the COA included in the fast BU message is not used by an arbitrary node, the DAD responding unit 93 transmits a fast BAck message including the detection result that refers to the COA as not being used. In this case, the value 0 is usable, for example, as a value that refers to the COA included in the fast BU message as usable. The value is recorded in the status field 701 of the fast BAck message.

On the other hand, when the DAD execution unit 92 detects that the COA included in the fast BU message is used by an arbitrary node, the DAD responding unit 93 transmits a fast BAck message that includes the detection result that refers to the COA as being used. In this case, the value 136 is usable, for example, as a value that refers to that the COA included in the fast BU message is detected as not usable. The value is recorded in the status field 701 of the fast BAck message.

The binding request reception unit 94 receives of the MN 6 from the MN 6. Namely, the binding request reception unit 94 receives the BU request from the MN 6 which had received the fast BAck message transmitted from the DAD responding unit 93. The BU message includes the COA which is detected as not used by an arbitrary node included in the sub-network B.

The BU unit 95 performs the BU in response to the request from the MN 6. Namely, the BU unit 95 performs the BU of the MN 6 by binding the COA included in the BU message received by the binding request reception unit 94 with the home address of the MN 6.

In response to the BU request received by the binding request reception unit 94, the binding responding unit 96 transmits a response to the BU request of the MN 6 . Namely, the binding responding unit 96 transmits to the MN 6 the BAck message to acknowledge that the BU of the MN 6 has been normally (successfully) performed by the BU unit 95.

When packets are received by the HA, the packet transmission/reception unit 97 tunnels the packets to the COA which is bound with the home address of the MN 6 due to the BU operation by the BU unit 95.

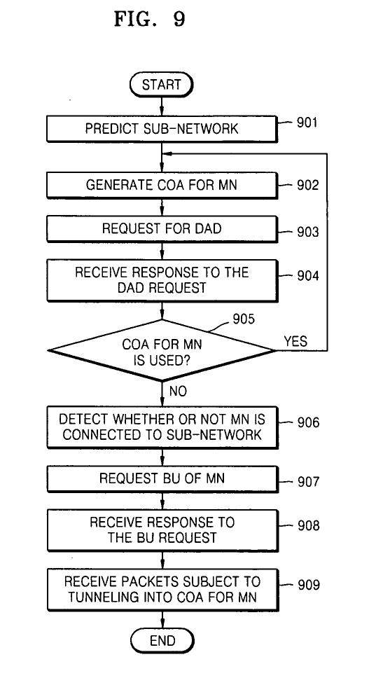

FIG. 9 is a flowchart of a handover method according to another aspect of the present invention. Referring to FIG. 9, the handover method according to an aspect of the present invention includes operations which are sequentially performed by the handover apparatus in the form of the MN 6 shown in FIG. 8. Accordingly, although omitted in the following description, the above-described components in the handover apparatus of the MN 6 shown in FIG. 8 will be applied to the handover method according to the aspect.

In operation 901, the MN 6 predicts (senses, detects, determines, and/or identifies) the sub-network B, namely, a sub-network which is likely to be connected to the MN 6. In operation 902, the MN 6 receives a router advertisement (RA) message from the NR 82 managing the sub-network B that includes the prefix of the sub-network B . The MN 6 also generates the COA for the MN 6 by combining the prefix of the sub-network B included in the RA message with the interface ID of the MN 6.

In operation 903, the MN 6 forwards or makes a request of the HA 9 for the DAD the COA generated in operation 902. Namely, in operation 903, the MN 6 transmits to the HA 9 the fast BU message that includes the COA generated in operation 902 to request the HA 9 to detect whether or not the COA for the MN 6 is already used by an arbitrary node included in the sub-network B.

In operation 904, the MN 6 receives a response to the DAD request of operation 903. Namely, in operation 904, the MN 6 receives the fast BAck message that includes a detected result of whether or not the COA generated in operation 902 is already used.

In operation 905, the MN 6 determines where or not the COA generated in operation 902 is already used by checking the value recorded in the status field 701 of the fast BAck message received in operation 904. According to a result of the determination, the operation proceeds to operation 906 (no in operation 905), or the operation of the method returns to operation 902 (yes in operation 905). Namely, in operation 905, when the value recorded in the status field 701 of the fast BAck message received in operation 904 refers to the COA as detected as not being used, the operation 906 is performed. In this case, the value is 0, for example. On the other hand, in operation 905, when the value recorded in the status field 701 of the fast BAck message received in operation 904 refers to the COA as detected as being used, , the procedure of the MN 6 returns to operation 902. In this case, when the value is 136, for example.

In operation 906, the MN 6 is notified that the MN 6 is disconnected from the AP1 71 included in the sub-network A which was previously connected to the MN 6 in the link layer. The link layer is the lowest layer of the IP layers. Also in operation 906, the MN 6 is connected to the AP2 72 included in the sub-network B. Accordingly, the connection of the MN 6 to the sub-network B is detected.

When the MN 6 is detected to be connected to the sub-network B in operation 906, the MN 6 selectively requests for the BU of the MN 6 based on the response to the request in operation 903 so that the MN 6 is connected to the sub-network B. More specifically, based on the determination of the MN 6 in operation 905 that the COA generated in operation 902 is not used, in operation 906, the MN 6 transmits the BU message including the COA to the HA 9 to request the HA 9 to bind the home address of the MN 6 with the COA that was generated in operation 902.

In operation 908, the MN 6 receives a response to the BU request made in operation 907. Namely, in operation 908, the MN 6 receives the BAck message to acknowledge that the BU of the MN 6 requested in operation 907 has been normally (successfully) performed.

In operation 909, based on the BAck message received in operation 908, the MN 6 receives the packets that are tunneled to the COA for the MN 6 by the HA 9.

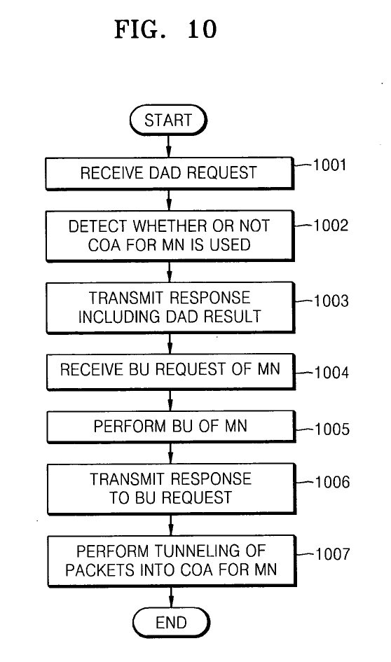

FIG. 10 is a flowchart of a handover supporting method according to another aspect of the present invention.

Referring to FIG. 10, the handover supporting method according to the aspect of the present invention includes operations which are sequentially carried out in the handover supporting apparatus in the form of the HA 9 shown in FIG. 8. Accordingly, although omitted in the following description, the above-described components in the handover supporting apparatus in the form of the MN 6 shown in FIG. 8 are applicable to the handover method according to the aspect.

In operation 1001, the HA 9 receives from the MN 6 the DAD request for the COA of the MN 6 to be used in the sub-network predicted likely to be connected to the MN 6. Namely, in operation 1001, the HA 9 receives from the MN 6 the fast BU message, which is the DAD request message that includes the COA for the MN 6.

In operation 1002, according to the request received in operation 1001, the HA 9 detects whether or not the COA for the MN 6 is used. Namely, when a value or an indication that refers to a request to detect whether or not the COA for the MN 6 is used as included in operation 1002, the HA 9 determines that the BU message received by the DAD request reception unit 91 is the fast BU message and detects whether or not the COA recorded in the mobility option field 619 of the fast BU message (of FIG. 6B) is used by an arbitrary node of the sub-network B.

In operation 1003, the HA 9 transmits a response that includes the DAD result of operation 1002 to the MN 6. Namely, when the COA included in the fast BU message is detected not to be used in operation 1002, in operation 1003, the HA9 transmits the fast BAck message that includes the detection result that indicates that the COA is detected as not used. In addition, when the COA included in the fast BU message is detected to be used in operation 1002, in operation 1003, the HA9 transmits the fast BAck message that includes a detection result that indicates that the COA is detected as used.

In operation 1004, the HA 9 receives the BU request from the MN 6 which had received the response transmitted in operation 1003. Namely, in operation 1004, based on the fast BAck message transmitted in operation 1003, the HA 9 receives the BU message from the MN 6 that includes the COA which is detected as not used by an arbitrary node included in the sub-network B.

In operation 1005, the HA 9 performs the BU of the MN 6 according to the request of the MN 6 that had received the response transmitted in operation 1003. Namely, in operation 1005, the HA 9 performs the BU of the MN 6 by binding the COA included in the BU message received in operation 1004 with the home address of the MN 6.

In response to the BU request received in operation 1004, in operation 1006, the HA 9 transmits the response to the BU request of the MN 6 to the MN 6. Namely, in operation 1006, the HA 9 transmits to the MN 6 the BAck message to acknowledge that the BU of the MN 6 was normally (or successfully) performed in operation 1005.

In operation 1007, when the packets, which are directed to the home address of the MN 6, are received from the CN 10, the HA 9 tunnels the packets to the COA that is bound with the home address of the MN 6 that occurred during the BU in operation 1005.

The aspects of the present invention can be written as computer programs and can be implemented in general-use digital computers that execute the programs using a computer readable recording medium to perform the method. In addition, a data structure used in the aspects of the present invention may be recorded in a computer readable recording medium though various means to perform the method.

Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

While not required, it is understood that the mobile node can be a computer, a phone, a PDA, and/or a mobile media player, and that aspects can be used in non-mobile devices accessing a network connection.

According to aspects of the present invention, a sub-network which is likely to be connected to a mobile node is predicted, and duplicate address detection for a care-of-address of the mobile node which is to be used in the sub-network is performed by a home agent instead of the mobile node. Accordingly, it is possible to prevent or reduce a handover delay caused by the duplicate address detection being performed by the mobile node.

In addition, according to the present invention, a mobile node makes or forwards a request to a home agent to perform a duplicate address detection by using only BU and BAck messages according to the mobile IPv6 standard without using a separately defined message, and receives a response to the request. Accordingly, it is possible to reduce load in the mobile node and cost involved in fast handover in comparison to a related art fast handover method using the separately defined message.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A handover method comprising:
identifying at a mobile node a sub-network which is likely to be connected to a mobile node prior to performing a handover from a prior sub-network;
requesting detection by a home agent of whether an address of the mobile node which is to be used in the sub-network is already used in the sub-network; and
selectively requesting performance of a binding update of the address of the mobile node based on a response to the detection request generated by the home agent.

2. The handover method of claim 1, wherein, when the response to the detection request indicates that the address is detected as not already used as the mobile node is connected to the sub-network, the requesting of the detection comprises requesting binding of the address with a home address of the mobile node.

3. The handover method of claim 1, wherein the requesting of the detection by the home agent comprises requesting the home agent to perform tunneling of packets which are directed to a home address of the mobile node into the address when used in the sub-network in which the mobile node is currently located.

4. The handover method of claim 1, wherein:
the requesting of the detection by the home agent comprises transmitting a request message that includes the address and receiving a response message that includes a detection result as to whether the address is already used, and
the selectively requesting of the performance comprises requesting binding of the address with a home address of the mobile node when the detection result included in the received response message indicates that the address is detected as not already used.

5. The handover method of claim 4, wherein the request message is a binding update message that includes a field in which an indicator indicating a request to detect whether the address is used, and a mobility option field.

6. The handover method of claim 1, further comprising generating an address different from the address when the response to the detection request indicates that the address is already used,
wherein the requesting of the detection by the home agent comprises requesting detection of whether the different address is already used.

7. A handover apparatus comprising:
an identification unit which identifies a sub-network which is likely to be connected to a mobile node;
a request unit which requests detection by the home agent of whether an address of the mobile node which is to be used in the sub-network is already used in the sub-network; and
a binding request unit which selectively requests performance of a binding update of the address of the mobile node based on a response to the detection request.

8. One or more computer readable recording media having embodied thereon a computer program for one or more computers to perform the handover method of claim 1.

9. A handover supporting method comprising:
detecting by a home agent whether an address of a mobile node which is to be used in a sub-network identified by the mobile node as likely to be connected to the mobile node is already used according to a request of the mobile node;
transmitting by the home agent a response including a result of the detection to the mobile node; and
performing by the home agent a binding update of the address of the mobile node according to a request of the mobile node which receives the response.

10. The handover supporting method of claim 9, wherein the performing of the binding update comprises performing the binding update of the mobile node by binding a home address of the mobile node with the address and performing tunneling of packets which are directed to the home address into the address that is bound with the home address.

11. The handover supporting method of claim 9, further comprising receiving a request message that includes the address,
wherein the detecting comprises detecting whether the address included in the received request message is already used.

12. The handover supporting method of claim 11, wherein the request message is a binding update message that includes a field in which an indicator indicating a request to detect whether the address is already used, and a mobility option field.

13. The handover supporting method of claim 9, wherein the transmitting of the response comprises transmitting a response message that includes an indicator that indicates the detection result of the address as already used.

14. The handover supporting method of claim 9, wherein the transmitting of the response comprises transmitting a response message that includes an indicator that indicates the detection result of the address as not already used.

15. A handover supporting apparatus comprising:
a detection unit which detects whether an address of a mobile node which is to be used in a sub-network identified as likely to be connected to the mobile node is already used according to a request of the mobile node;
a responding unit which transmits a response including a result of the detection of the detection unit; and
a binding update unit which performs a binding update of the address of the mobile node according to a request of the mobile node which receives the response.

16. One or more computer readable recording media having embodied thereon a computer program for one or more computers to perform the handover supporting method of claim 9.

17. A fast handover method between one sub-network and another sub-network and involving a mobile node and a home agent, the method comprising:
the mobile node detecting the another sub-network as a next visited sub-network;
the mobile node generating a care-of-address for use in the another sub-network;
the mobile node forwarding the care-of-address and a duplicate address detection request based on the care-of-address to the home agent;
the home agent performing the duplicate address detection to determine if the care-of-address is usable in the another sub-network; and
if usable, the mobile node requesting a binding update of the care-of-address to a home address of the mobile node.

18. The fast handover method of claim 17, wherein the care-of-address is generated by combining a prefix of the another sub-network and an Interface ID of the mobile node.

19. The fast handover method of claim 17, wherein the care-of-address is usable if the care-of-address is not already used in the another sub-network.

20. The fast handover method of claim 17, wherein, if the binding update is successful, packets directed to the home address of the mobile node is tunneled to the care-of-address of the mobile node.

21. A system to implement a fast handover method, the system comprising:
a mobile node to identify a sub-network which is likely to be connected to the mobile node, to send a detection request to detect of whether an address of the mobile node which is to be used in the sub-network is already used in the sub-network, and to selectively request performance of a binding update of the address based on a detection response to the sent detection request; and
a home agent to detect whether the address of the mobile node is already used according to the sent detection request of the mobile node, to transmit the detection response to the mobile node including a result of whether the address is already used, and to perform the requested binding update of the address of the mobile node.

22. The system as claimed in claim 21, wherein when the detection response indicates that the address is detected as not already used, the address is bound with a home address of the mobile node during the binding update.

23. The system as claimed in claim 21, wherein the detection request comprises a request for the home agent to perform tunneling of packets which are directed to a home address of the mobile node into the address once the address is bound with a home address of the mobile node during the binding update.
